(19) United States
(12) Patent Application Publication
(10) Pub. No.: US 2003/0046051 A1
(43) Pub. Date: Mar. 6, 2003

(54) Unified design parameter dependency management method and apparatus

(76) Inventors: William R. Wheeler, Southborough, MA (US); Matthew J. Adiletta, Worcester, MA (US); Timothy J. Fennell, Holliston, MA (US)

Correspondence Address: FISH & RICHARDSON, PC, 4350 LA JOLLA VILLAGE DRIVE, SUITE 500, SAN DIEGO, CA, 92122, US

(21) Appl. No.: 09/994,574

(22) Filed: Nov. 26, 2001

Related U.S. Application Data
(60) Provisional application No. 60/315,852, filed on Aug. 29, 2001.

(51) Int. Cl. G06F 7/60

(52) U.S. Cl. 703/14

(57) ABSTRACT

Managing signal parameters in a logic design typically includes defining a signal parameter with a value, maintaining the defined signal parameter in a central database, and using the defined signal parameter that is maintained in the central database in computer code for a logic design.

### CROSS-REFERENCE TO RELATED APPLICATIONS

This application claims priority from U.S. Provisional Application No. 60/315,852, filed Aug. 29, 2001, and titled “Visual Modeling and Design Capture Environment,” which is incorporated by reference.

### TECHNICAL FIELD

This invention relates to a unified design parameter dependency management method and apparatus.

### BACKGROUND

The logic design process may be broken into different tasks, such as, for example, design, capture, documentation, compilation, simulation, and debug. Many logic designers may be involved in the logic design process. During some of the tasks, such as, for example, design and capture, managing design parameters (e.g., signal parameters) may be a complex and time-consuming process, especially when design changes are made that may affect numerous aspects of the logic design.

### DESCRIPTION OF DRAWINGS

FIG. 1 is a block diagram of a computer system.

FIG. 2 is a block diagram of a data word.

FIG. 3 is a block diagram of a table in a database.

FIG. 4A is a block diagram of a portion of computer code.

FIG. 4B is a block diagram of a portion of computer code.

FIG. 5 is a flow chart of a process for managing signal parameters.

Like reference symbols in the various drawings indicate like elements.

### DETAILED DESCRIPTION

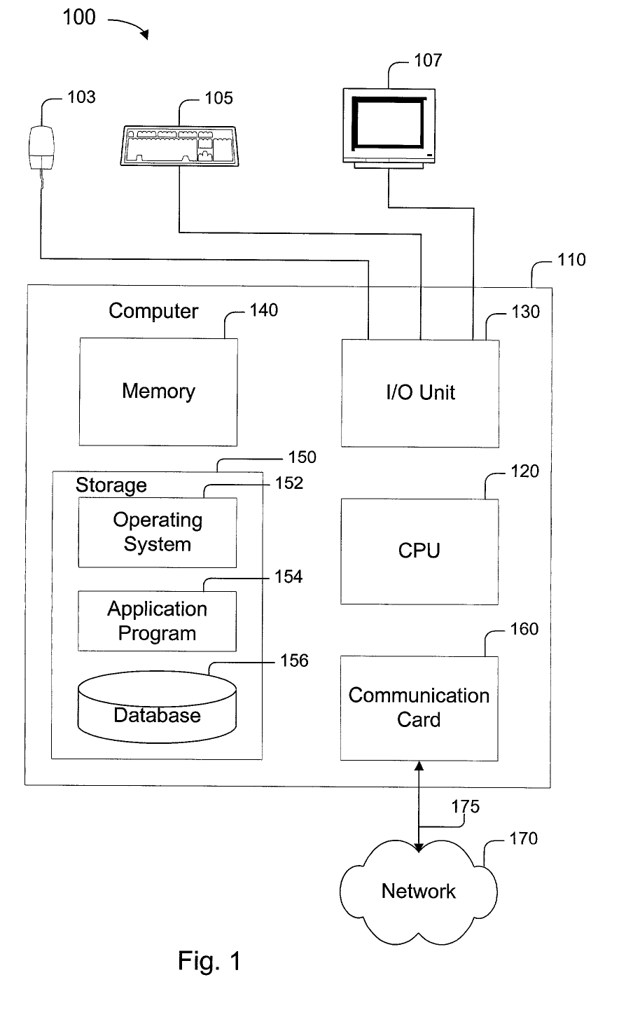

FIG. 1 illustrates an exemplary system 100 such as a computer system that may be used in the logic design process. The system 100 may include various input/output (I/O) devices (e.g., mouse 103, keyboard 105, and display 107) and a general purpose computer 110 having central processor unit (CPU) 120, I/O unit 130, memory 140, and storage 150. Storage 150 may store machine-executable instructions, data, and various programs such as an operating system 152, one or more application programs 154, and one or more databases 156, all of which may be processed by CPU 120.

System 100 also may include a communications card or device 160 (e.g., a modem and/or a network adapter) for exchanging data with a network 170 using a communications link 175 (e.g., a telephone line, a wireless network link, a wired network link, or a cable network). Other examples of system 100 may include a personal computer, a desktop computer, a notebook computer, a handheld device, a workstation, a server, a device, a component, other equipment, or some combination of these capable of responding to and executing instructions in a defined manner.

System 100 may be arranged to operate in concert with one or more similar systems to facilitate the logic design process. At least one of the systems 100 may include a central database, such as, for example, database 156 stored in storage 150, for use during the logic design process. The central database may be stored on one system 100 or may be partitioned and stored on more than one system 100. The central database typically is accessible to the users involved in the logic design process (e.g., designers, architects). For example, the central database may be integrated into the logic design process as part of a logic design module that performs one or more of the logic design tasks.

In a logic design, wires or signals may be used to connect the various components (e.g., logic blocks, logic gates). The signals may include a single bit signal or a multiple bit signal. The signals may be represented in a graphical model, which also may include a textual description, and/or a textual model.

In the case of multiple bit signals, the bit width of the signal typically must match the width of the pins on the logic component to which the signal connects. A multiple bit signal may be defined by one or more signal parameters. The signal parameters may include a signal label, a signal width, one or more bit fields with labels for each bit field, the width of the bit fields, and the position of the bit fields within the signal.

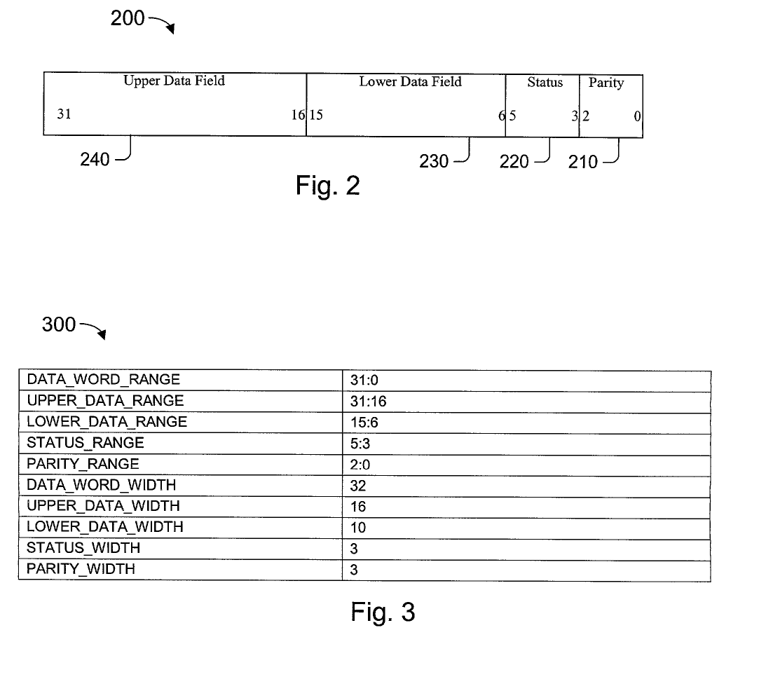

Multiple signals with varying signal parameters may be used in a logic design. For example, FIG. 2 illustrates a multiple-bit signal 200 that includes a three bit parity field 210 located in bit positions 0-2, a three bit status field 220 located in bit positions 3-5, a ten bit lower data field 230 located in bit positions 6-15, and a sixteen bit upper data field 240 located in bit positions 16-31. Signal 200 may be used by numerous designers in the logic design process and may permeate throughout the logic design and interface with multiple components.

The central database, described above, may be used to manage the numerous signals and signal parameters. The central database provides a single repository to store the signal parameters used in the logic design. The central database may be searchable.

The signal parameters may be arranged and stored in the central database in various formats. For example, FIG. 3 illustrates a table 300 using one possible format to define the signal parameters related to signal 200 of FIG. 2. Table 300 includes a label for the signal (Data_Word_Range) and the bit positions for the signal (31:0). Table 300 also includes a label for the bit fields within the signal and their corresponding bit positions (e.g., Upper_Data_Range with bit positions (31:16), Lower_Data Range with bit positions (15:6), Status_Range with bit positions (5:3), and Parity Range with bit positions (2:0)). Table 300 also includes a separate label for the bit width of the signal and each of the bit fields (e.g., Data_Word_Width is 32 bits wide, Upper_Data_Width is 16 bits wide, Lower Data Width is 10 bits wide, Status Width is 3 bits wide, and Parity Width is 3 bits wide).

Logic designers and architects use the signal parameters maintained in the central database when performing the tasks of logic design (e.g., design and capture). The central database is integrated with the logic design tool used by the logic designers and architects in performing these logic design tasks. For example, the logic design tool may be used to create textual format and/or graphical format logic designs. When two different designers use the same signal parameters in a portion of the design, uniformity of design is possible. Additionally, when modifications are made to the signals and the signal parameters, the modifications may be made in the central database without necessarily having to change the logic already created by each individual designer.

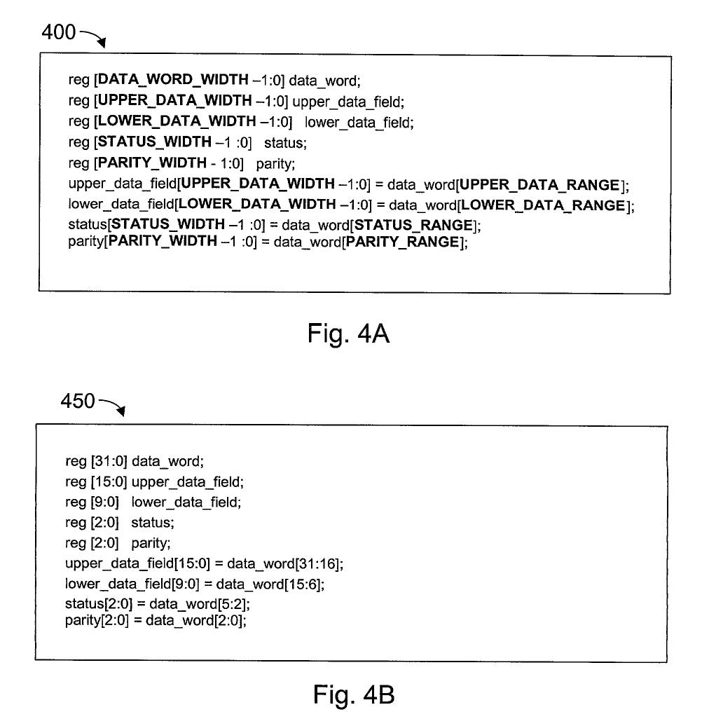

For example, FIG. 4A illustrates a table 400 of a portion of computer code that may be used as part of a logic design. The computer code may include a Hardware Design Language (HDL), such as Verilog (IEEE Standard 1364) or a Very High Speed Integrated Circuit Hardware Design Language (VHDL). Verilog includes a textual format for describing a logic design that includes electronic circuits and systems.

The computer code uses the signal parameter labels defined in the central database to construct the logic design. The logic design tool that may be used to create the computer code in table 400 is linked to the integrated central database that includes the parameter labels and their definitions. Additionally, the central database is compatible with the format of the computer code. For instance, the central database is compatible with computer code that includes a “TIC_define” format (e.g., used with Verilog) for use with signal parameters.

Thus, if a change is made to one or more of the signal parameters, the change is made in the database and the computer code is updated automatically to reflect the changes made in the database. Because the labels are used in the code, the code itself does not need to be rewritten to reflect modifications to the signal parameters.

In contrast, for example, FIG. 4B illustrates a table 450 of a portion of computer code that uses constants, instead of the signal parameter labels defined in the central database, to construct the logic design. In this instance, since the signal parameters labels were not used, there is no relationship between the logic design and the central database. When a signal parameter is modified, the computer code that includes the constants needs to be manually updated. Manually updating the computer code may be a complex and time-consuming task.

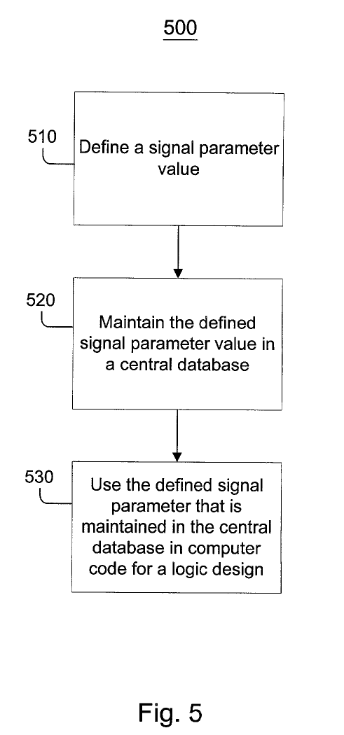

FIG. 5 illustrates a process 500 for managing signal parameters. Process 500 typically includes defining one or more signal parameters with a value (510), maintaining the defined signal parameters in a central database (520), and using the defined signal parameters that are maintained in the central database in computer code for a logic design (530).

Process 500 may further include modifying the value of the defined signal parameter in the central database, and automatically modifying the logic design with the modified value of the defined signal parameter. Thus, the computer code does not need to be modified manually when a signal parameter modification is made.

When a signal parameter is modified in the database, the textual format and/or the graphical format of the logic design may indicate any discrepancies that may have resulted from the signal parameter modification. For example, if the width of a signal is modified in the central database, then a discrepancy between the signal and any of the logic components that use that signal may be indicated. For instance, if the signal was originally defined in the central database as having a width of thirty-two bits and the width is subsequently modified to a width a sixty-four bits, then any occurrence of that signal in the logic design may be flagged for a user to see that a change to the signal has been made.

The indication that a discrepancy exists may be a visual indication in the graphic format of the logic design, such as, by changing the color of the signal (e.g., changing the color of the signal from green to red, or changing the color of a logic component or a portion of the logic component to which the signal connects from green to red), or by bolding, highlighting, italicizing, or providing some other visual cue as to the discrepancy. A similar visual indication may be made in the textual format of the logic design (e.g., a visual indication in the computer code for the logic design).

Additionally or alternatively, a textual cue may be provided in the graphic format of the logic design to indicate that a discrepancy exist.

Other examples of signal parameter modifications that may be made include modifying the position of a bit field within a signal, modifying the width of a bit field within the signal, and modifying the width of the signal. Modifications may include additions, deletions, and updates.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device for execution by a programmable processor.

A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of nonvolatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made. For example, advantageous results still could be achieved if steps of the disclosed techniques were performed in a different order and/or if components in the disclosed systems were combined in a different manner and/or replaced or supplemented by other components. Also, for instance, it is possible to use a central database that includes design parameters or a portion of that central database for more than one logic design. Accordingly, other implementations are within the scope of the following claims.

What is claimed is:

1. A system comprising:
a logic design module operational to be used by one or more users in logic design tasks; and
a central database integrated with the logic design module and including signal parameters that are accessible to use by the users of the logic design module in the logic design tasks.

2. The system of claim 1 wherein:
the central database includes modifications to the signal parameters, and
the logic design module is structured and arranged to generate a logic design and to update the logic design automatically based on the modifications to the signal parameters in the central database.

3. The system of claim 2 wherein the logic design module is structured and arranged to indicate design discrepancies automatically in the logic design resulting from the modifications to the signal parameters in the central database.

4. The system of claim 3 wherein the indicated design discrepancies include a bit width error.

5. The system of claim 1 wherein the signal parameters include a signal bit width and a value for the signal bit width.

6. The system of claim 1 wherein the signal parameters include a signal bit position and a value for the signal bit position.

7. A method comprising:
defining a signal parameter with a value;
maintaining the defined signal parameter in a central database; and
using the defined signal parameter that is maintained in the central database in computer code for a logic design.

8. The method of claim 7 further comprising:
updating the value of the defined signal parameter in the central database; and
automatically updating the logic design with the updated value of the defined signal parameter.

9. The method of claim 8 further comprising automatically indicating design discrepancies occurring in the logic design that result from updating the value of the defined signal parameter.

10. The method of claim 9 wherein automatically indicating design discrepancies occurring in the logic design includes graphically indicating a bit width error.

11. The method of claim 7 wherein the signal parameter includes a signal bit width and the value includes a value for the signal bit width.

12. The method of claim 7 wherein the signal parameter includes a signal bit position and the value includes a value for the signal bit position.

13. The method of claim 7 wherein the signal parameter includes a bit field and the value includes a value for the bit field.

14. The method of claim 7 further comprising accessing the central database by one or more users.

15. An apparatus comprising:
a central database accessible by one or more users;
one or more signal parameters defined in the central database;
a value for the signal parameters; and
an interface between the central databases and a logic design module that uses the signal parameters in a logic design.

16. The apparatus of claim 15 wherein the signal parameters include a signal bit width and the value includes a value for the signal bit width.

17. The apparatus of claim 15 wherein the signal parameters include a signal bit position and the value includes a value for the signal bit position.

18. A machine-accessible medium, which when accessed results in a machine performing operations comprising:
defining a signal parameter with a value;
maintaining the defined signal parameter in a central database; and
using the defined signal parameter that is maintained in the central database in computer code for a logic design.

19. The machine-accessible medium of claim 18 further comprising:
updating the value of the defined signal parameter; and
automatically updating the logic design with the updated value of the defined signal parameter.

20. The machine-accessible medium of claim 19 further comprising automatically indicating design discrepancies occurring in the logic design that result from updating the value of the defined signal parameter.

21. The machine-accessible medium of claim 20 wherein automatically indicating design discrepancies occurring in the logic design includes graphically indicating a bit width error.

22. The machine-accessible medium of claim 18 wherein the signal parameter includes a signal bit width and the value includes a value for the signal bit width.

23. The machine-accessible medium of claim 18 wherein the signal parameter includes a signal bit position and the value includes a value for the signal bit position.

24. The machine-accessible medium of claim 18 wherein the signal parameter includes a bit field and the value includes a value for the bit field.

25. The machine-accessible medium of claim 18 further comprising permitting one or more users to access the central database.
